(19) United States
(12) Patent Application Publication
(10) Pub. No.: US 2011/0225410 A1
(43) Pub. Date: Sep. 15, 2011

(54) ELECTRONIC DEVICE AND BOOTING UP METHOD

(75) Inventor: Kuo-Shu HUNG, Tu-Cheng (TW)

(73) Assignee: HON HAI PRECISION INDUSTRY CO., LTD., Tu-Cheng (TW)

(21) Appl. No.: 12/773,016

(22) Filed: May 4, 2010

(30) Foreign Application Priority Data
Mar. 12, 2010 (CN) 201010123731.7

(51) Int. Cl. G06F 9/00

(52) U.S. Cl. 713/2

(57) ABSTRACT

An electronic device includes a micro control unit (MCU), a non-volatile random access memory (NVRAM), and a watch dog. The electronic device detects a standby instruction and then enters a standby mode according to the standby instruction. A boot loader stored in the NVRAM boots the electronic device when the MCU detects a starting instruction. The electronic device triggers the watch dog to time a preset period when the boot loader boots the electronic device and boots up with a fast mode. The electronic device determines if the watch dog times out, and boots up with a normal mode when the electronic device does not boot up with the fast mode before the watch dog times out.

### BACKGROUND

1. Technical Field

Embodiments of the present disclosure relate to electronic devices, and more particularly to an electronic device and a booting up method thereof.

2. Description of Related Art

When an electronic device shuts down, power sent to all hardware of the electronic device are shut down, such as to a central process unit (CPU), and a dynamic random access memory (DRAM). Therefore, data in those hardware is discarded. When the electronic device boots up next time, the electronic device needs to reload the data to those hardware, which results in a longer boot up time of the electronic device.

Currently, the electronic device can enter a standby mode to cut down on the boot up time of the electronic device. The electronic device which enters the standby mode moves the data from the CPU to the DRAM and makes the DRAM to work under lowest power consumption. When it boots up again, the electronic device recovers the data from the DRAM to the CPU, which results in a faster boot up time of the electronic device. The booting up process is called booting up by a fast mode.

However, the data stored in the DRAM may be damaged because of many factors, such as thunder or static electricity. When the data stored in the DRAM is damaged, the electronic device cannot boot up. Therefore, a system to resolve this weakness is required.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of functional modules of one embodiment of an electronic device of the present disclosure;

FIG. 2 is a flowchart of one embodiment of a method of the electronic device of FIG. 1 entering a standby mode; and

FIG. 3 is a flowchart of a booting up method of one embodiment of the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

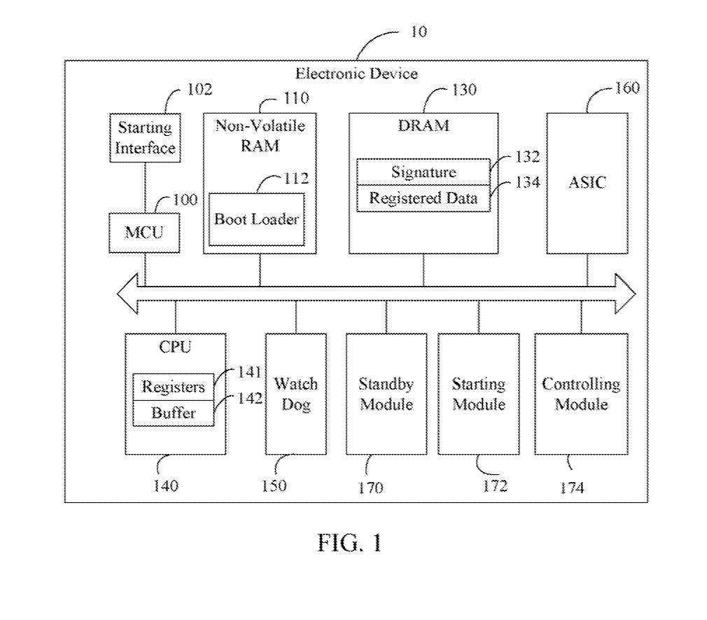

FIG. 1 is a schematic diagram of functional modules of one embodiment of an electronic device 10 of the present disclosure. The electronic device 10 may be a set top box (STB), a personal computer, or any other devices. In one embodiment, the electronic device 10 includes a microcontroller unit (MCU) 100, a starting interface 102, a non-volatile random access memory (NVRAM) 110, a dynamic random access memory (DRAM) 130, a central processing unit (CPU) 140, a watch dog 150, and an application specific integrated circuit (ASIC) 160.

The starting interface 102 provides an interface for the electronic device 10 to receive a starting instruction. For example, if the electronic device 10 is a STB employing an infrared remote control to boot up, the starting interface 102 may be an infrared receiver to receive the starting instruction from the infrared remote control. If the electronic device 10 is a personal computer employing a button to boot up, the starting interface 102 may be the button.

The MCU 100 connects to the starting interface 102 and detects the starting instruction by the starting interface 102. The NVRAM 110 stores a boot loader 112 to boot the electronic device 10 when the MCU 100 detects the starting instruction. Here, the boot loader 112 is a small program that initiates a bootstrap process. It should be understood that the boot loader 112 boots the electronic device 10 by loading an operating system or an embedded operating system of the electronic device 10. The ASIC 160 implements specific functions of the electronic device 10, such as processing video or audio codecs.

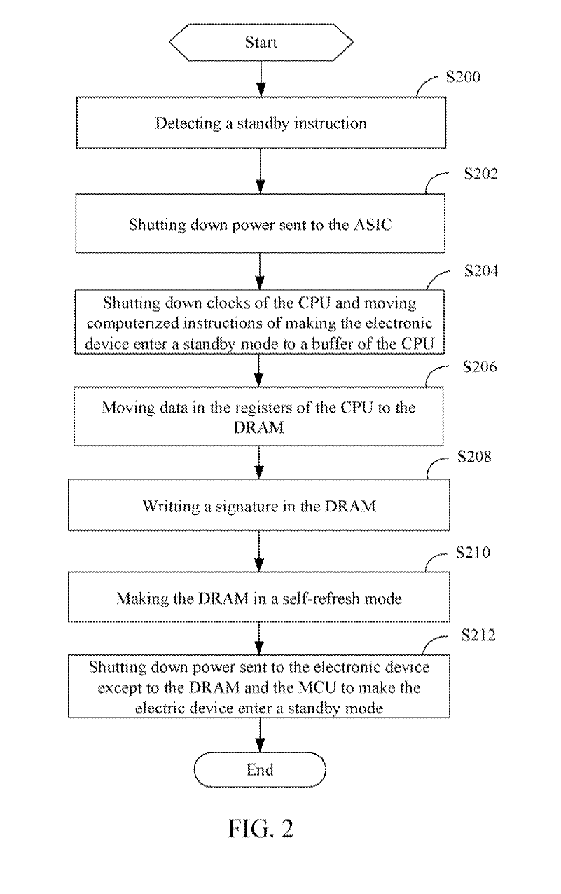

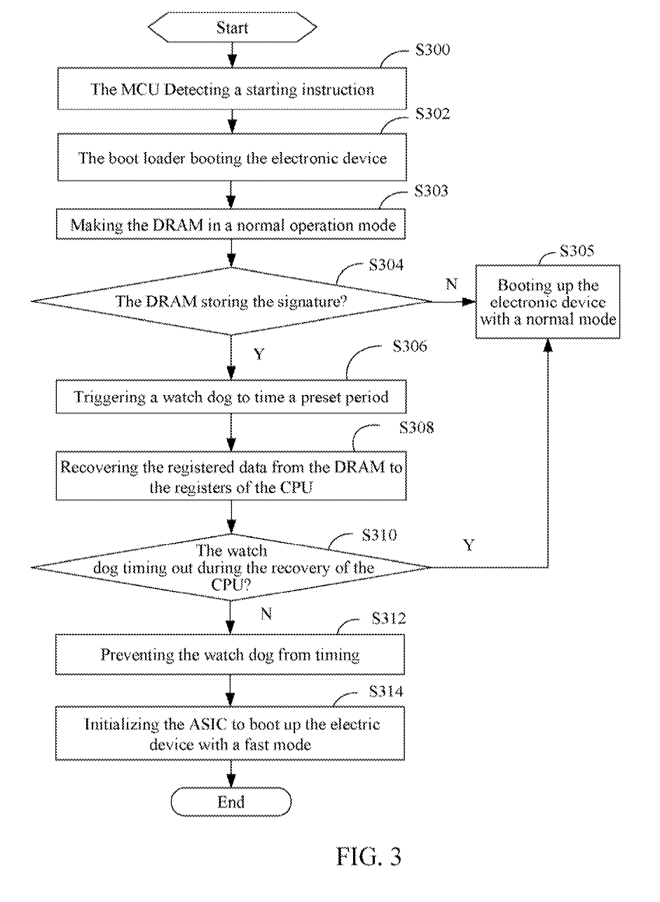

In one embodiment, the electronic device 10 further includes a standby module 170, a starting module 172, and a controlling module 174. Those modules 170, 172 and 174 may include one or more computerized instructions stored in the DRAM 130 and executed by the CPU 140. Function description of those modules is shown in detail description of FIG. 2 and FIG. 3.

FIG. 2 is a flowchart of one embodiment of a method of the electronic device 10 of FIG. 1 entering a standby mode. The flowchart is executed by the standby module 170 of FIG. 1. Depending on the embodiment, additional blocks may be added, others deleted, and the ordering of blocks may be changed while remaining well within the scope of the disclosure.

In block S200, the standby module 170 detects a standby instruction. If the standby instruction has been received, then in block S202, the standby module 170 shuts down power sent to the ASIC 160. In block S204, the standby module 170 shuts down clocks of the CPU 140 and moves computerized instructions of making the electronic device 10 enter the standby mode to a buffer 142 of the CPU 140 from the DRAM 130.

In block S206, the standby module 170 moves data registered in registers 141 of the CPU 140 to the DRAM 130. The registers 141, such as 32 microprocessor without interlocked piped stages (MIPS) registers, translation lookaside buffer (TLB) registers, co-processor registers, and a program counter, store data for the CPU 140. Thus, the DRAM 130 stores registered data 134 (e.g., data of the registers of the CPU 140). When the standby module 170 completes the movement of the registered data 134, in block S208, the standby module 170 writes a signature 132 in the DRAM 130 to indicate the electronic device 10 can boot up with a fast mode at next time. In this embodiment, the fast mode means booting up fast after entering the standby mode. The detail description of the electronic device 10 booting up with the fast mode is shown in block S300, S302, S303, S308, and S314 of FIG. 3.

Here, the DRAM 130 works in a normal operation mode. In block S210, the standby module 170 makes the DRAM 130 in a self-refresh mode. Here, the self-refresh mode is a mode where the DRAM is active but requires a little bit electric power, substantially 8-10 milliamperes. In block S212, the standby module 170 shuts down system power sent to the electronic device 10 except to the DRAM 130 and the MCU 100. Thus, the electronic device 10 enters the standby mode, and only the DRAM 130 and the MCU 100 consume electric power under this situation. The DRAM 130 shuts down current requirement from substantially 350 milliamperes in the normal operation mode to 8-10 milliamperes in the self-refresh mode, which effectively decreases power consumption of the electronic device 10.

FIG. 3 is a flowchart of a booting up method of one embodiment of the present disclosure. The flowchart is primarily executed by the starting module 172 and the controlling module 174 of FIG. 1. Before the block S300, in the electronic device 10, only the DRAM 130 and the MCU 100 are electric power supplied. Depending on the embodiment, additional blocks may be added, others deleted, and the ordering of blocks may be changed while remaining well within the scope of the disclosure.

In block S300, the MCU 100 detects a starting instruction by the starting interface 102. In block S302, the boot loader 112 in the NVRAM 110 boots the electronic device 10. Here, the DRAM 130 works in the self-refresh mode. In block S303, the starting module 172 makes the DRAM 130 in the normal operation mode. In block S304, the starting module 172 determines if the DRAM 130 stores the signature 132.

If the DRAM 130 does not store the signature 132, which means the electronic device 10 does not enter the standby mode previously, the electronic device 10 cannot boot up with the fast mode. Under this situation, in block S305, the starting module 172 boots up the electronic device 10 with the normal mode.

If the DRAM 130 stores the signature 132, which means the electronic device 10 enters the standby mode previously, the electronic device 10 can boot up with the fast mode. Under this situation, in block S306, the controlling module 174 triggers the watch dog 150 to time a preset period. The preset period is determined according to a time period cost on the booting up of the electronic device 10 with the fast mode. The preset period is a little bit longer than the time period cost on the booting up of the electronic device 10 with the fast mode. For example, if the booting up of the electronic device 10 with the fast mode cost 10 seconds, then the preset period of the watch dog 150 may be preset as 12 seconds.

In block S308, the starting module 172 recovers the registered data 134 from the DRAM 130 to the CPU 140. In block S310, the starting module 172 determines if the watch dog 150 times out during the recovery of the registered data 134 to the CPU 140. If the watch dog 150 times out during the recovery of the registered data 134 to the CPU 140, which means the registered data 134 in the DRAM 130 are damaged, the electronic device 10 cannot boot up with the fast mode. Therefore, in block S305, the starting module 172 boots up the electronic device 10 with the normal mode.

If the watch dog 150 does not time out after the recovery of the registered data 134 to the CPU 140, then the electronic device 10 can successfully boot up with the fast mode. In block S312, the controlling module 174 prevents the watch dog 150 from timing. In block S314, the starting module 172 initializes the ASIC 160 to boot up the electronic device 10 with the fast mode.

The electronic device 10 of the present disclosure employs the watch dog 150 to detect whether the booting up with the fast mode is completed on schedule or not. Subsequently, the electronic device 10 can boot up with the fast mode when the booting up with the fast mode is completed on schedule, and can further boot up with the normal mode when the booting up with the fast mode is not completed on schedule as the registered data 134 in the DRAM 130 is damaged. Therefore, the electronic device 10 avoids a situation that the electronic device 10 cannot boot up after entering the standby mode. The present disclosure overcomes the hidden trouble of the booting up of the electronic device 10 with the fast mode and improves reliability of the booting up of the electronic device 10.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. An electronic device comprising a microcontroller unit (MCU), a non-volatile random access memory (NVRAM), a dynamic random access memory (DRAM), a central processing unit (CPU), a watch dog, a boot loader stored in the NVRAM to boot the electronic device when the MCU detects a starting instruction, and one or more programs stored in the DRAM and operable to be executed by the CPU, the one or more programs comprising:
a standby module operable to detect a standby instruction, wherein the electronic device enters a standby mode according to the standby instruction;
a controlling module operable to trigger the watch dog to time a preset period when the boot loader boots the electronic device; and
a starting module operable to boot up the electronic device with a fast mode, determine if the watch dog times out, and boot up the electronic device with a normal mode upon the condition that the electronic device does not boot up with the fast mode when the watch dog times out.

2. The electronic device as claimed in claim 1, wherein the controlling module is further operable to prevent the watch dog from timing upon the condition that the electronic device boots up with the fast mode when the watch dog times out.

3. The electronic device as claimed in claim 1, wherein to make the electronic device enter the standby mode, the standby module is operable to shut down clocks of the CPU and move computerized instructions of making the electronic device enter the standby mode to a buffer of the CPU from the DRAM.

4. The electronic device as claimed in claim 3, wherein to make the electronic device enter the standby mode, the standby module is further operable to move data registered in the CPU to the DRAM, and to write a signature in the DRAM when the movement of the registered data is completed.

5. The electronic device as claimed in claim 4, wherein to make the electronic device enter the standby mode, the standby module is further operable to make the DRAM in a self-refresh mode, and to shut down system power sent to the electronic device except to the DRAM and the MCU.

6. The electronic device as claimed in claim 5, wherein to boot up the electronic device with the fast mode, the starting module is operable to make the DRAM in a normal operation mode and determine if the DRAM stores the signature.

7. The electronic device as claimed in claim 6, wherein to boot up the electronic device with the fast mode, the starting module is further operable to recover the registered data from the DRAM to the CPU upon the condition that the DRAM stores the signature.

8. The electronic device as claimed in claim 6, wherein the starting module is further operable to boot up the electronic device with the normal mode upon the condition that the DRAM does not store the signature.

9. A booting up method of an electronic device, the electronic device comprising a microcontroller unit (MCU), a boot loader stored in a non-volatile random access memory (NVRAM), a dynamic random access memory (DRAM), a central controlling unit (CPU), and a watch dog, the method comprising:
detecting a standby instruction, wherein the electronic device enters a standby mode according to the standby instruction;
the MCU detecting a starting instruction;
the boot loader booting the electronic device;
triggering the watch dog to time a preset period;
booting up the electronic device with a fast mode;
determining if the watch dog times out; and
booting up the electronic device with a normal mode if the electronic device does not boot up with the fast mode when the watch dog times out.

10. The method as claimed in claim 9, further comprising preventing the watch dog from timing if the electronic device boots up with the fast mode before the watch dog times out.

11. The method as claimed in claim 9, wherein the electronic device entering the standby mode comprises:
shutting down clocks of the CPU and moving computerized instructions of making the electronic device enter the standby mode to a buffer of the CPU from the DRAM;
moving data registered in the CPU to the DRAM;
writing a signature in the DRAM when the movement of the registered data is completed;
making the DRAM in a self-refresh mode; and
shutting down system power sent to the electronic device except to the DRAM and the MCU.

12. The method as claimed in claim 11, wherein booting up the electronic device with the fast mode comprises:
making the DRAM in a normal operation mode;
determining if the DRAM stores the signature; and
recovering the registered data from the DRAM to the CPU if the DRAM stores the signature.

13. The method as claimed in claim 12, further comprising booting up the electronic device with the normal mode if the DRAM does not store the signature.
